(19) United States
(12) Patent Application Publication
(10) Pub. No.: US 2011/0273291 A1
(43) Pub. Date: Nov. 10, 2011

(54) Drowning prevention system

(76) Inventor: Donald Adams, Tallahassee, FL (US)

(21) Appl. No.: 12/799,875

(22) Filed: May 4, 2010

(51) Int. Cl. G08B 19/00; G01J 5/00

(52) U.S. Cl. 340/552; 340/541; 250/338.1

(57) ABSTRACT

A method for providing a security barrier proximate a body of water such as a lake or a swimming pool. One or more beams—preferably infra red light beams—define the barrier. A detector is positioned to monitor each beam so that a moving object “cutting” the beam can be detected by a controller in communication with the beam or beams. A motion detector monitors for motion in a broad area around the location of the security perimeter. The motion detector is also in communication with the controller. The controller deactivates the beams and relies solely on the motion detector when no objects are near the perimeter. Once the motion detector senses an object in the area of the perimeter, however, the controller activates the beams. If an object then interrupts a beam, the controller activates an alarm.

### CROSS-REFERENCES TO RELATED APPLICATIONS

Not applicable.

### STATEMENT REGARDING FEDERALLY SPONSORED RESEARCH OR DEVELOPMENT

Not applicable.

### MICROFICHE APPENDIX

Not applicable

### BACKGROUND OF THE INVENTION

1. Field of the Invention

The present invention relates generally to the field of water safety. More specifically, the invention comprises a method for electronically monitoring a boundary around a body of water and generating an alarm if the boundary is crossed.

2. Description of the Related Art

Accidental drownings in swimming pools and other bodies of water are an increasing problem. The drowning victims are generally toddlers, who fall into the water and drown before an adult realizes they are missing. Security around swimming pools has traditionally been provided by a fence. While such a perimeter does provide security, it is subject to human error in that gates are often left open or exterior dwelling doors leading to the pool area may be left unlatched. A lapse of only a few minutes can unfortunately result in a tragic death.

Other accidental drownings occur in bodies of water that have not traditionally been secured by a fence. Examples include lakes and streams. It is impractical to fence such bodies of water. It is therefore desirable to provide a drowning prevention system which can be applied to pools, lakes, and other bodies of water.

### BRIEF SUMMARY OF THE INVENTION

The present invention comprises a method for providing a security barrier proximate a body of water such as a lake or a swimming pool. One or more beams—preferably infra red light beams—define the barrier. A detector is positioned to monitor each beam so that a moving object “cutting” the beam can be detected by a controller in communication with the beam or beams.

A motion detector monitors for motion in a broad area around the location of the security perimeter. The motion detector is also in communication with the controller. The controller deactivates the beams and relies solely on the motion detector when no objects are near the perimeter. Once the motion detector senses an object in the area of the perimeter, however, the controller activates the beams. If an object then interrupts a beam, the controller activates an alarm.

### BRIEF DESCRIPTION OF THE SEVERAL VIEWS OF THE DRAWINGS

FIG. 1 is a perspective view, showing a simple detection path using a single emitter and detector.

FIG. 2 is a plan view, showing the use of photodetectors to establish a protected zone around a swimming pool.

FIG. 3 is a schematic view, showing a hard wired configuration for a photodetector-based protection system.

FIG. 4 is a schematic view, showing a wireless configuration for the system of FIG. 3.

FIG. 5 is a perspective view, showing an embodiment including a base station and one or more remote units.

FIG. 6 is a plan view, showing the deployment of a base station with three remote units.

FIG. 7 is a plan view, showing the use of the inventive method to form a monitoring boundary along a lake shore.

REFERENCE NUMERALS IN THE DRAWINGS

| | | | |
|---|---|---|---|
| 10 | emitter | 12 | detector |
| 14 | IR beam | 16 | controller |
| 18 | wiring | 20 | mount |
| 22 | pool | 24 | dwelling |
| 26 | fence | 28 | external power |
| 30 | power circuit | 32 | detection circuit |
| 34 | audio alarm | 36 | visual alarm |
| 38 | motion detector | 40 | transceiver |
| 42 | battery | 44 | R/F module |
| 46 | base station | 48 | housing |
| 50 | pedestal | 52 | leg |
| 54 | housing | 56 | solar panel |
| 58 | turntable | 60 | lake shore |
| 62 | strobe | | |

### DETAILED DESCRIPTION OF THE INVENTION

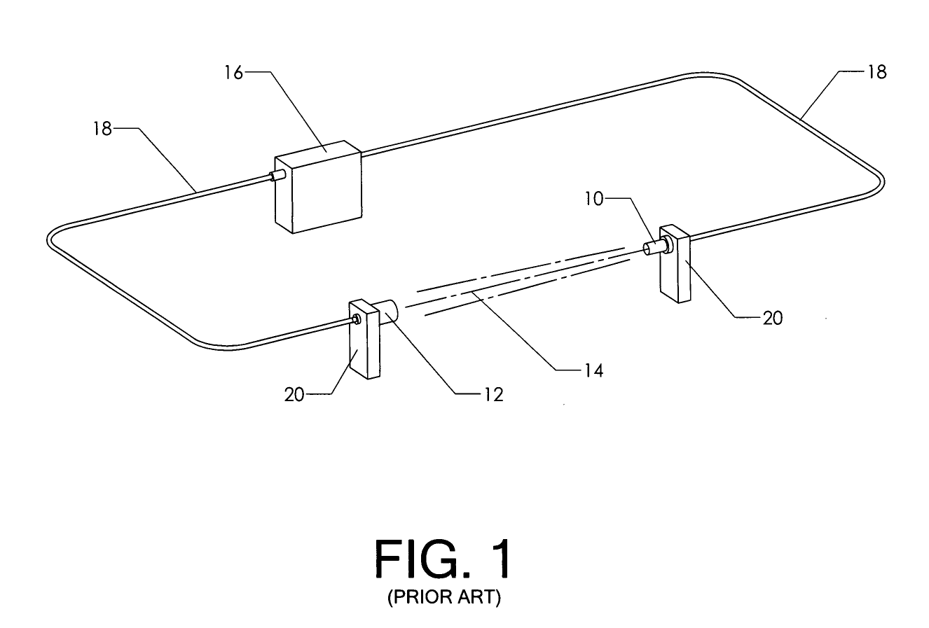

The inventive method can be carried out using a virtually endless variety of components and connections. FIGS. 1-7 illustrate preferred embodiments. However, the invention is by no means confined to the embodiments disclosed.

FIG. 1 illustrates a prior art detector system using a photodetector. Emitter 10 emits a focused beam of infrared light—labeled as IR beam 14 in the view. The emitter is oriented to project this beam upon detector 12. Detector 12 is configured to monitor for the presence of IR beam 14. Mounts 20 are used to maintain the desired alignment between the emitter and the detector. When the beam is “seen” by the detector, it typically sends a positive signal to controller 16 over wiring 18.

When an object interrupts the optical path, detector 12 no longer “sees” IR beam 14. An appropriate signal is sent to controller 16 which interprets the receipt of the signal as an interruption in the beam. The emitter, the detector, and the beam therebetween may be referred to as a “beam set.” Those skilled in the art will realize that the emitter and detector may be reversed in a particular beam set. In other words, mounting the emitter on one end of the line to be monitored versus the other is a design choice.

The controller typically includes logic devices which can apply error-correction algorithms to the detection functions. As an example, the controller typically samples the input from the detector at a fixed rate—such as 1,000 samples per second. The controller might require a beam interruption of 1/100 of a second (or 10 cycles) before “concluding” that the beam has been interrupted by an object of interest—such as a passing toddler.

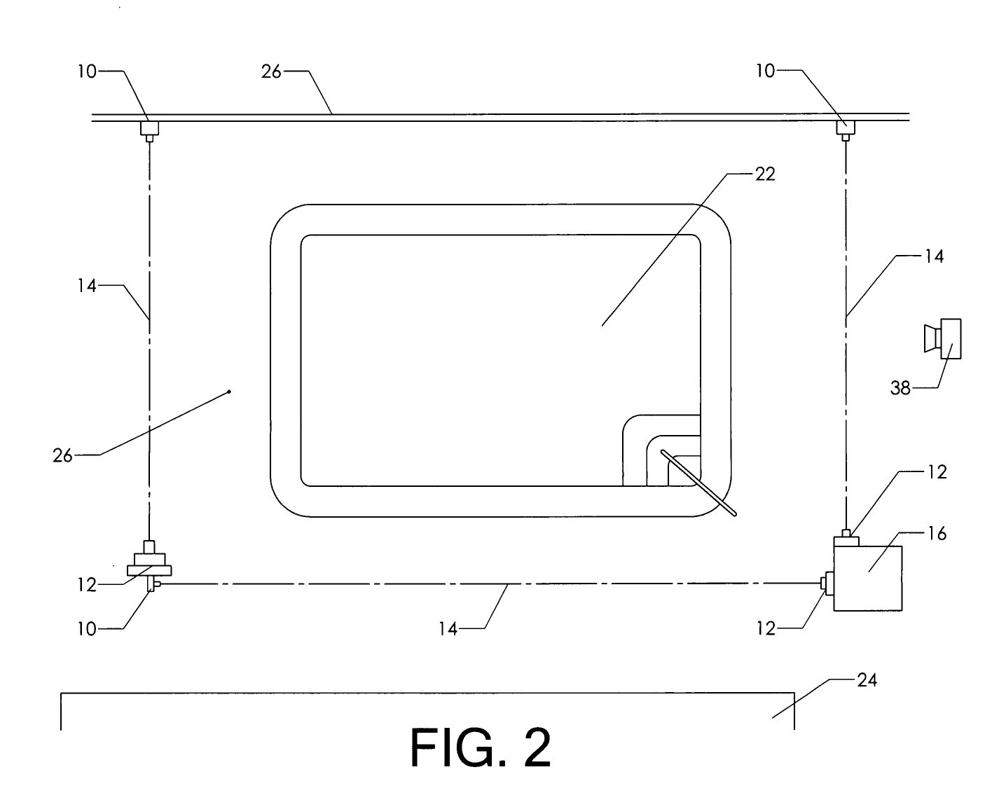

The present inventive method proposes to use such photodetection devices as part of an integrated pool safety system. FIG. 2 is an elevation view of a pool 22 located near dwelling 24. The objective in this example is to form a rectangular perimeter completely enclosing the pool. Fence 26 forms part of the perimeter. As this particular fence has no breaks—such as a gate—it forms an effective portion of the containment system. Three IR beams 14 are placed to form the rest of the desired rectangle. Two emitters 10 are placed on fence 26. These direct IR beams toward two detectors 12 positioned at the lower vertices (in the orientation shown in the view) of the rectangular perimeter. Another emitter/detector pair is positioned to form the final side of the rectangle.

All the emitter and detector pairs communicate with controller 16, which monitors for any interruption of one of the IR beams 14. Motion sensor 38 is also provided. It also communicates with controller 16 for reasons that will be explained subsequently.

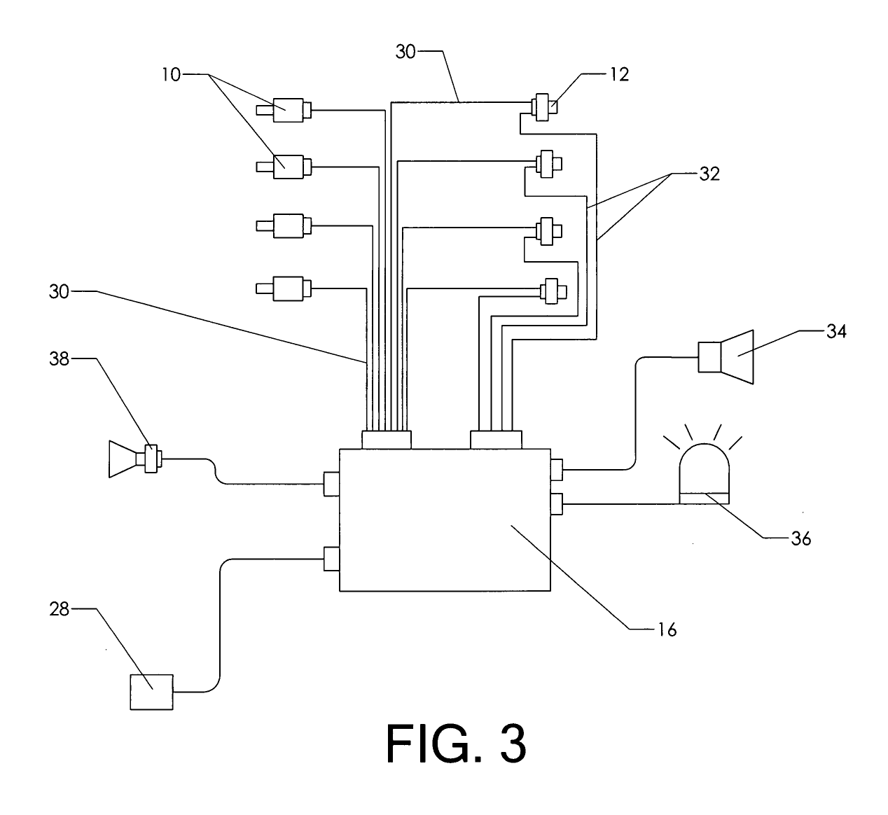

FIG. 3 is a schematic view illustrating the interaction of the components used in the present inventive method. Controller 16 is the central point of communication. One or more emitters 10 are connected to the controller. One or more detectors 12 are likewise connected. The emitters are provided with power circuits 30 so that electrical power can be provided from the controller to the emitters. The emitters are essentially a focused infrared light source. They typically just need power without the need for logic circuitry.

Detectors 12 also need power circuits. However, in addition to the power circuits, the detectors need detection circuits 32 which are used to communicate whether a particular detector senses the presence of an IR beam. The detectors preferably have other features to aid the user in installing the system. The IR beams are not visible to the naked eye. Hence, it is difficult for a user to ensure that the emitter beam is properly aligned with the detector. Visible or audible indicators are preferably provided on the detector. These indicate to the user that the detector is currently sensing the IR beam.

As an example, each detector can be provided with a visible LED which illuminates when the IR beam strikes the detector. When the user is aligning the components, he or she can watch for the illumination of the LED.

Motion sensor 38 is connected to controller 16 as well. The motion sensor is preferably a sensor having a wide field of view—such as an ultrasonic detector. It detects motion in the vicinity of the pool and provides the detection information to the controller, which can then use the motion detection signal to trigger other actions.

Controller 16 also controls alarm devices such as audio alarm 34 and visual alarm 36. The alarm systems are preferably immediate in nature, since the hazard the system guards against must be addressed immediately. The audio alarm is preferably a loud siren or klaxon. The visual alarm is preferably a bright flashing light or strobe. The controller may also control other more remote types of alarms—such as phone communications, text messaging, etc.

Power is provided to controller 16 via external power 28. This may assume many forms. Preferably low voltage power is provided for safety reasons. A transformer may be connected to 110VAC in a dwelling and a low voltage line then run out to the power supply. An internal battery is preferably provided so that operation can continue during a power outage. The external power source could also be a solar array or wind turbine.

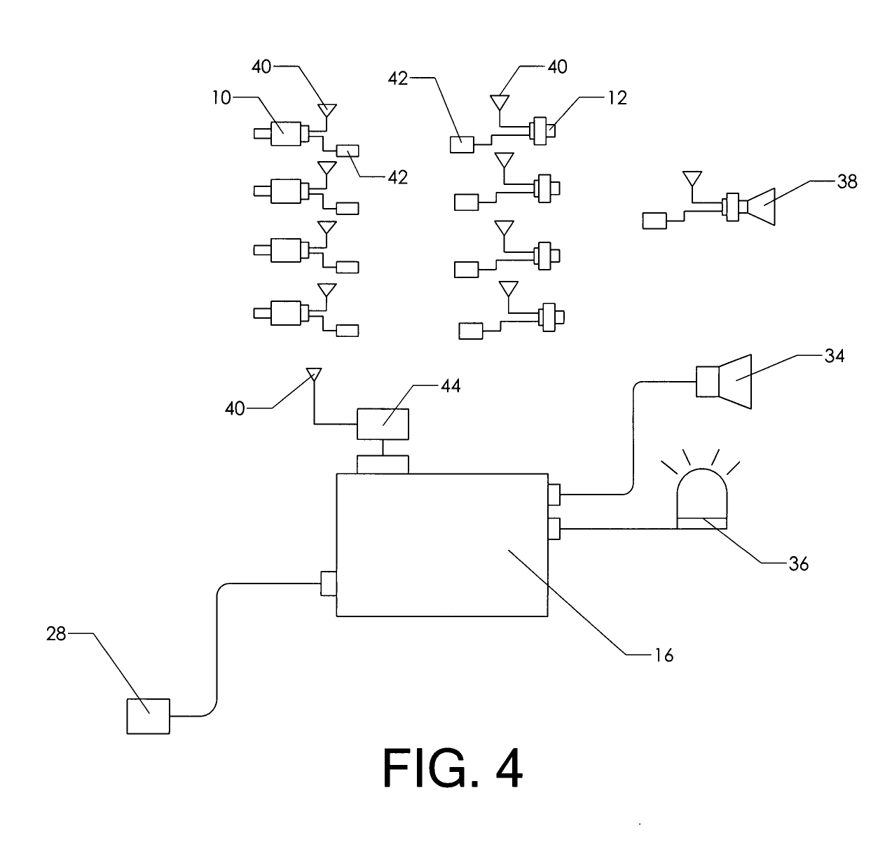

FIG. 4 shows a second embodiment in which wireless communication is used. The term “wireless” communications should properly be thought of as including any technology which is not hard wired. Examples include radio frequency communications, infra-red communications, and ultrasonic communications. As radio frequency transceivers are widely available at moderate cost, radio communications are preferred.

Each emitter 10 shown in FIG. 4 has an associated transceiver 40 which can receive and transmit radio communications. Each emitter also has its own power source such as a battery 42. Motion sensor 38 is likewise equipped with its own power source. One or more emitters or detectors can be attached to a single power source. The power source need not be limited to a battery. As one example, a small solar panel could be used to power the emitters and/or detectors.

Controller 16 is otherwise configured as for the embodiment of FIG. 3, except that signals coming to and from the emitters and detectors pass through R/F module 44, which communicates through another transceiver 40. One may wonder why signals need to be sent to the emitters—since they are typically passive devices. However, since the remote components in the system of FIG. 4 run off their own power, it is important to conserve the power available. Thus, the emitters are only switched on when needed—as will be explained subsequently.

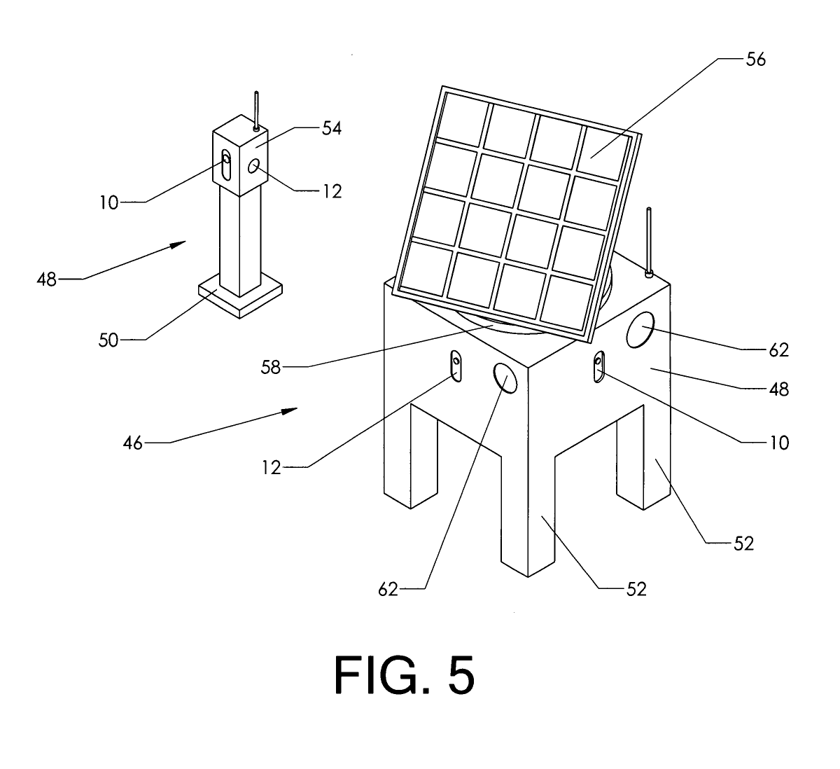

The components depicted in the schematics of FIGS. 3 and 4 may be physically realized in a variety of forms. FIG. 5 shows one possible embodiment. Base station 46 contains the controller in housing 48. The housing is raised off the ground by a plurality of legs 52. Two sides of the housing are used to mount some of the beam devices. An emitter 10 is located on one side and a detector 12 is located on a second side.

In this embodiment solar panel 56 provides power to the controller and other devices within base station 46. The solar panel is preferably mounted on turntable 58 so that it may track the progress of the sun in order to maximize energy input. The visual warning comprises a series of strobes 62 placed around the perimeter of the housing. These emit bright flashes if the system detects something breaking an IR beam. An internal siren provides the desired audible alarm.

One or more remote units 48 are provided to operate in conjunction with base station 46. Each remote unit can contain an emitter 10 and a detector 12 (in order to form a “corner” of a rectangular perimeter as depicted in FIG. 2). Housing 54 may be mounted on a pedestal 50 in order to raise it above the ground. Each remote unit may be equipped with an internal power source—such as a battery, solar panel, or wind turbine.

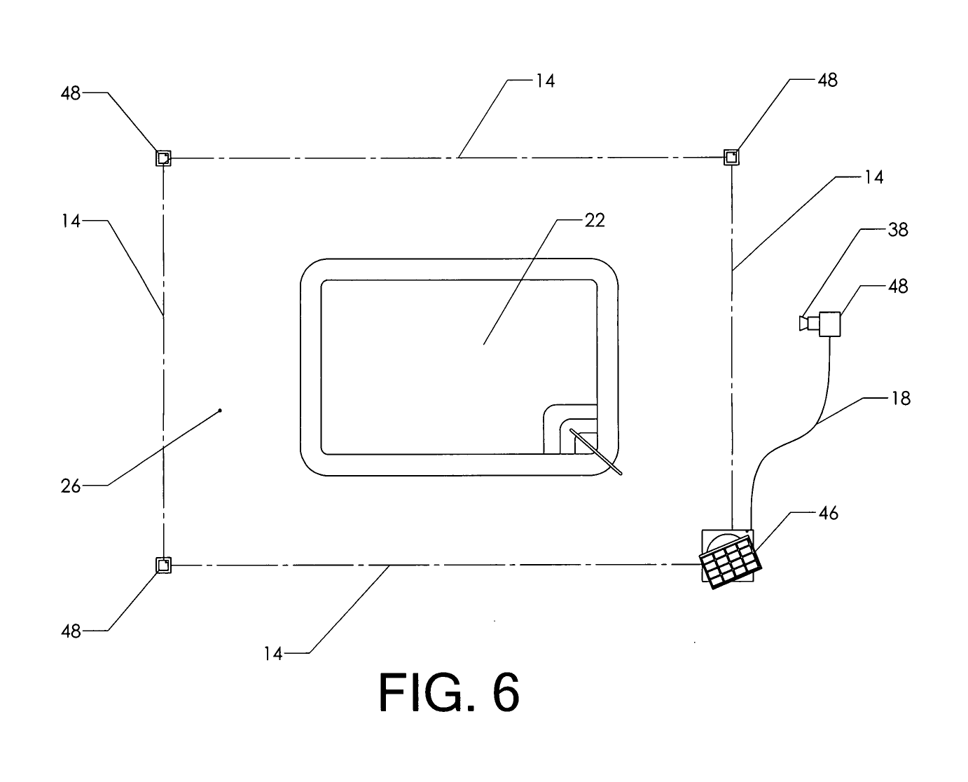

FIG. 6 shows an installation in which a base station 46 is used in conjunction with three remote units to create a rectangular perimeter of IR beams 14 around pool 22. The rectangular perimeter creates a suitable protected area 26 adjacent to the pool. The controller monitors this perimeter. A fourth remote unit 48 is used to mount motion sensor 38. The motion sensor in this embodiment may be power by its own battery or may be hard wired to the base station so that it can draw power from the base station. The motion sensor is preferably a broad area device—such as an ultrasonic sensor. It monitors a larger area than that enclosed within the rectangular perimeter.

The operation of the inventive method will now be described with respect to FIG. 6. It is desirable for the system to remain in an active state at all times. However, since the system is dependent upon available or stored solar power, it is undesirable to have all the functions active at all times. Motion sensor 38 monitors the broad area around the system. The controller in the base station assumes a low-level mode in which it only controls the motion sensor and monitors for motion anywhere near the pool. No other components (aside from the motion sensor) are powered at this time).

When the motion sensor detects motion in the vicinity of the pool, the controller “awakens” and activates the emitters and detectors to establish the IR beam perimeter. The perimeter remains active for a selected period of time. As an alternative, the perimeter can remain active until motion sensor 38 no longer detects any motion.

The components may be rapidly activated. As an example, the entire perimeter could be transitioned from a dormant to an active state within 1 millisecond. Thus, even an object rapidly advancing toward the pool will be detected by the motion sensor and the protective perimeter will be activated before the object can cross one of the IR beams.

The use of the motion sensor to activate and deactivate the system will prevent many false alarms. As an example, during periods where the system is activated to guard the pool, an adult guest may walk around the area of the pool to retrieve an item. The IR beams will be activated in this scenario. As long as the adult guest does not cross an IR beam, however, the alarm will not be activated.

Of course, one can configure the system so that all the components remain active at all times. This would be possible where the system is supplied with external AC power and the rate of power consumption is not a big factor. However, even where external AC power is available, considerations of energy efficiency make the embodiment in which the motion sensor monitors for activity the preferred embodiment.

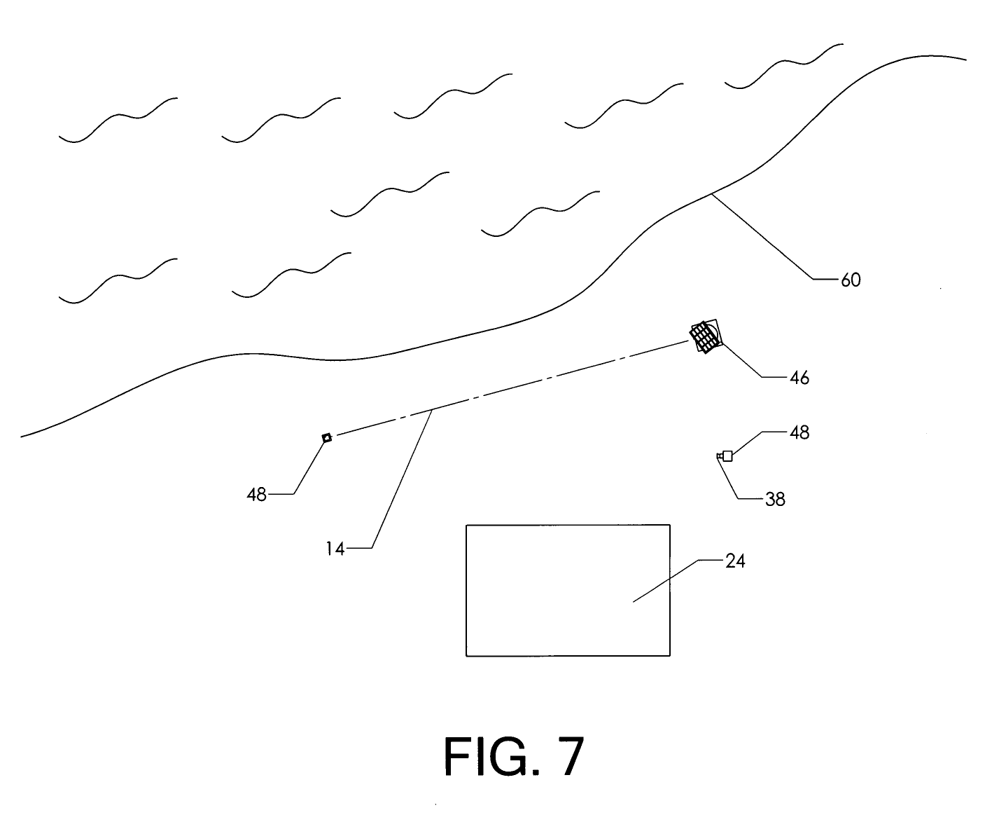

The use of internal power also allows the system to be portable. FIG. 7 shows the use of a portable embodiment in which a boundary between dwelling 24 and lake shore 60 is to be monitored. Motion sensor 38 provides information regarding whether there is a moving object in the vicinity of IR beam 14. When a moving object is detected, IR beam 14 is activated and the controller monitors for any break in the beam.

The reader will thereby appreciate that the present invention provides a method for guarding a body of water such as a pool. The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

Having described my invention, I claim:

1. A method for providing a security barrier proximate a body of water, comprising:
a. providing a controller;
b. providing a motion sensor in communication with said controller;
c. providing at least one monitored beam set, with said monitored beam set being in communication with said controller;
d. providing an alarm device in communication with said controller;
e. placing said at least one monitored beam set proximate said body of water;
f. placing said motion sensor proximate said body of water and orienting said motion sensor so that said motion sensor detects moving objects proximate said at least one monitored beam;
g. having said controller monitor said motion sensor;
h. having said controller activate said at least one monitored beam set upon motion being detected by said motion sensor; and
i. having said controller activate said alarm device upon detecting an interruption in said at least one monitored beam set.

2. A method for providing a security barrier as recited in claim 1, wherein:
a. said at least one monitored beam set is located remotely from said controller; and
b. said communication between said at least one monitored beam set and said controller assumes the form of radio frequency communications.

3. A method for providing a security barrier as recited in claim 1, wherein:
a. said motion sensor is located remotely from said controller; and
b. said communication between said motion sensor and said controller assumes the form of radio frequency communications.

4. A method for providing a security barrier as recited in claim 2, wherein said at least one monitored beam set includes its own internal power source.

5. A method for providing a security barrier as recited in claim 3, wherein said motion sensor includes its own internal power source.

6. A method for providing a security barrier as recited in claim 1, wherein:
a. said controller is housed in a base station;
b. at least a portion of said at least one monitored beam set is housed in said base station; and
c. at least a portion of said at least one monitored beam set is housed in a remote unit.

7. A method for providing a security barrier as recited in claim 6, wherein said base station includes a solar panel providing power to said controller.

8. A method for providing a security barrier as recited in claim 6, wherein power is provided to said base station from an AC source.

9. A method for providing a security barrier as recited in claim 1, wherein:
a. said at least one monitored beam set is located remotely from said controller; and
b. said communication between said at least one monitored beam set and said controller is a hard wired connection.

10. A method for providing a security barrier as recited in claim 1, wherein:
a. said motion sensor is located remotely from said controller; and
b. said communication between said motion sensor and said controller is a hard wired connection.

11. A method for providing a security barrier proximate a body of water, comprising:
a. providing a controller;
b. providing at least one emitter emitting a focused infra red beam, said at least one emitter being in communication with said controller;
c. providing at least one detector, said at least one detector being positioned to detect said focused infra red beam from said at least one emitter, said at least one detector being in communication with said controller;
d. said at least one emitter and said at least one detector being positioned so that said focused infra red beam lies proximate said body of water;
e. providing a motion sensor in communication with said controller, said motion sensor being positioned to detect motion proximate said focused infra red beam;
f. having said controller activate said motion sensor to monitor for said motion proximate said focused infra red beam;
g. having said controller activate said at least one emitter and said at least one detector upon motion being detected by said motion sensor; and
h. having said controller activate said alarm device upon detecting an interruption in said focused infra red beam.

12. A method for providing a security barrier as recited in claim 11, wherein:
a. said at least one emitter is located remotely from said controller; and
b. said communication between said at least one emitter and said controller assumes the form of radio frequency communications.

13. A method for providing a security barrier as recited in claim 11, wherein:
a. said motion sensor is located remotely from said controller; and
b. said communication between said motion sensor and said controller assumes the form of radio frequency communications.

14. A method for providing a security barrier as recited in claim 12, wherein said at least one emitter includes its own internal power source.

15. A method for providing a security barrier as recited in claim 13, wherein said motion sensor includes its own internal power source.

16. A method for providing a security barrier as recited in claim 11, wherein:
a. said controller is housed in a base station;
b. said at least one detector is housed in said base station; and
c. said at least one emitter is housed in a remote unit.

17. A method for providing a security barrier as recited in claim 16, wherein said base station includes a solar panel providing power to said controller.

18. A method for providing a security barrier as recited in claim 16, wherein power is provided to said base station from an AC source.

19. A method for providing a security barrier as recited in claim 11, wherein:
a. said at least one detector is located remotely from said controller; and
b. said communication between said at least one detector and said controller is a hard wired connection.

20. A method for providing a security barrier as recited in claim 11, wherein:
a. said motion sensor is located remotely from said controller; and
b. said communication between said motion sensor and said controller is a hard wired connection.
